(19) United States
(12) Patent Application Publication
(10) Pub. No.: US 2016/0278471 A1
(43) Pub. Date: Sep. 29, 2016

(54) PROCEDURE FOR MAKING ELASTICIZED FOOTWEAR AND PRODUCT OBTAINED WITH THIS PROCEDURE

(71) Applicants: Gabriele DOMENIGHINI, Trawniki (PL); Agnieszka PYLAK, Trawniki (PL); PIEFFE SPORT S.N.C. DI ROSSIGNOLI FRANCESCO, PAOLO & C., Bovolone (IT)

(72) Inventors: Paolo Rossignoli, Bovolone (IT); Francesco Rossignoli, Bovolone (IT)

(21) Appl. No.: 15/034,547

(22) PCT Filed: Nov. 5, 2014
(86) PCT No.: PCT/IB2014/065811

§ 371 Date: May 4, 2016

(30) Foreign Application Priority Data
Nov. 5, 2013 (IT) VR2013A000238

(51) Int. Cl. A43B 3/10; A43B 13/04; A43D 3/02; B29D 35/06; A43B 13/14

(52) U.S. Cl. CPC A43B 3/101; B29D 35/061; A43B 13/141; A43D 3/026; A43B 13/04

(57) ABSTRACT

A procedure for making elasticized footwear of the mule type or similar, where the elasticized footwear comprises two parts, a base part (10), comprising a knitted sock, on which is applied by means of thermoform moulding zones or tread sections (11) of rubber or silicon material to form a sole in sections and where the elasticized footwear is obtained by employing a procedure comprising the following steps: a) the production of a sock (10) using a machine to make several sections with different degrees of elasticity; b) mounting the sock on an aluminium shoemaker's last (12); c) inserting the sock mounted on the last into a mould (13) to fill the cavity (14) which is suitably shaped to form the raised tread sections (11) which after injection are fixed to the sock to form the sole; d) the injection of a thermoplastic material into the mould in order to apply to the sole of the sock and adjoining areas one or more tread sections (11) made from rubber or silicon material which adhere perfectly to the sock sole to give it the characteristics of maximum flexibility and adherence; e) post-injection cooling of the closed mould at a controlled temperature; f) opening of the mould, extraction of the injected sock followed by finishing and cutting off of the injection runners and sprues.

### TECHNICAL FIELD

The present invention relates to a procedure for making elasticized footwear and the product obtained with this procedure.

In particular, the invention relates to a procedure for making elasticized footwear where the footwear produced by the procedure consists of sock which becomes an elasticized mule slipper with the particular characteristic that the same model can be used for groups of sizes. The footwear is therefore very versatile.

The procedure for making elasticized footwear according to the invention consists of putting a suitably elasticized sock on a shoemaker's last and inserting the sock and last assembly into a mould for direct injection moulding. The direct injection moulding process applies portions or sections of rubber, silicon or other suitable material to the sole and nearby areas of the sock.

This invention can be applied in the footwear industry and in particular in the sector for making mules and other footwear for domestic use.

### BACKGROUND ART

It is known that the footwear industry produces footwear models with a wide variety of different characteristics and that models are usually designed for a specific use.

Known examples include everyday footwear and sports footwear both made according to different designs appropriate to the activity for which they will be used.

In the sector for footwear for domestic indoor use one of the most widely known and used items is the slipper, a pair of slippers being the typical type of footwear used in the home.

Slippers are different from mules in that they are closed. In comparison with shoes, slippers are designed for different uses and are made from different materials. Slippers and mules must fit well and be comfortable and must be warm in winter. This is why soft leather, cloth, felt, velvet and other types of lined fabric are used for the uppers.

Mules are not used outdoors and their soles can therefore be made not only of leather but also of felt. Often the soles have a rubber non-slip, noise damping rubber coating. Mules are slip-on rather than lace-up. Particularly high models can have a zip, a button or elastic closing.

Given that they are made from soft material, they can be made by hand, knitted, crocheted or sewn.

Traditional mules require a considerable amount of material for their production given the many models each with their own sizes. This means that various different models for the sole, the upper, the sock lining and the other parts are required, each part requiring its own size versions.

Currently, this means that in order to make traditional mules in five sizes, for example from size 41 to size 45, requires five different mule models. This involves considerable expenditure for the materials which have to be held in stores and for the labour needed for manufacturing. It is, for example, necessary to use moulds and other machinery which have to be retooled each time the model size being manufactured is changed.

Documents FR2692114 and FR116627A5 describe known solutions where the first case involves the manufacture of a traditional, non-slip sock obtained by applying inserts on the knitwear and the second case describes a sock or tights made using traditional methods. However, in both cases it is necessary to make various models with different sock sizes, in other words, it is not possible to make a single model which suits a single range of sizes.

### DESCRIPTION OF THE INVENTION

The present invention provides an innovative procedure for manufacturing elasticized footwear of the mule type which makes it possible to eliminate or at least reduce the drawbacks described above.

The present invention provides a procedure for manufacturing elasticized footwear of the mule type for use in domestic environments which are very simple to make and comfortable to use.

This purpose is achieved by a procedure for manufacturing elasticized footwear for use in domestic environments with the characteristics described in the main claim.

The dependent claims of the solution in this invention describe advantageous embodiments of the invention.

The principal advantages of this solution, in addition to all those which derive from its simple, easy to manufacture design, primarily concern the fact that the footwear can be manufactured with standard equipment and is so elasticized that one or two models can cover all the sizes that customers will request.

To manufacture the mule according to the present invention involves making a sock model suitably elasticised and made in several sections where each section has a different degree of elasticity and then mounting this sock on an aluminium last. Next, the sock mounted on the aluminium last is inserted into a thermoplastic injection moulding machine which applies one or more sections of rubber, silicone or other material suitable for the purpose to the sole of the sock.

### DESCRIPTION OF THE DRAWINGS

Other features and advantages of the invention will become clear on reading the description given below of one embodiment, provided as a non-limiting example, with the help of the accompanying drawings, in which:

FIG. 1 is a diagram showing the underside of the footwear according to the present invention;

FIG. 2 is a diagram showing a side view of the footwear according to the present invention;

FIG. 3 shows a cross-section of the mould in which the sock is inserted once it has been applied to the aluminium last;

FIG. 4 is a partial cut-away view of the mould showing the designs forming the outer surface of the rubber or latex inserts applied to the sock;

FIGS. 5 and 6 are diagrams of the mould according to the present invention and designed to receive the sock mounted on the aluminium last;

FIG. 7 is a cross-section of the mould along the line A-A in FIG. 6.

### DESCRIPTION OF ONE EMBODIMENT OF THE INVENTION

The accompanying figures show the procedure according to the present invention designed for making elasticized domestic footwear or mules substantially comprising two parts: a base part indicated by the numeral 10, comprising a knitted sock, on which is applied by means of thermoform moulding, zones or tread sections 11 of rubber or silicon material to form a sole in sections.

The elasticized mule is obtained by employing a procedure comprising the following steps:
a) the production of a sock using a machine to make several sections with different degrees of elasticity;
b) mounting the sock on an aluminium shoemaker's last 12;
c) inserting the sock mounted on the aluminium last into a low-pressure, low-speed, controlled injection volume mould 13 to fill the cavity 14 which is suitably shaped to form the raised tread sections 11 which after injection are fixed to the sock to form the sole;
d) the injection of a thermoplastic material into the mould in order to apply to the sole of the sock and adjoining areas one or more tread sections 11 made from rubber or silicon material which adhere perfectly to the sock sole to give it the characteristics of maximum flexibility and adherence;
e) post-injection cooling of the closed mould at a controlled temperature;
f) opening of the mould, extraction of the injected sock followed by finishing and cutting off of the injection runners and sprues.

The sock is made by forming the four sections shown in FIG. 2.

PART A has an initial edge made from 20% Lycra covered with 80% nylon.

PART B is made using Milkofil 20/1 comprising 35% milk fibre, 65% cotton with 14% Lycra interlaced with 86% nylon.

PART C is the same as part B.

PART D is the same as parts B and C with the addition of 20% Lycra covered with 80% nylon.

PART A—The initial edge of the sock is made with extra swings so that it is possible to work with more than half of the needles usually employed for the classic heel. The machine uses 10 extra needles per part.

At the start of the edge all the needles are cast on for two revolutions; at the third revolution the thread of the odd needle is held back and is cast off at the end of the edge. The even needle knits on both the forward and return strokes. This type of machining makes it possible to work an elastomer alone. In ‘normal conditions’ the result would not be the same and a double edge would be created.

PART B—Comprising the classic terry heel with extra swings.

PART C—Heel with extra swings with the first and last needle held so as to obtain a heel without closing the sock and does not ladder from the initial to the final needles.

PART D—Part D is divided into two parts: INITIAL and FINAL with normal cylinder rotation.

The initial part is made with 20 revolutions where the hooks are cast on to make the double edge so that the sock does not roll up.

In order to ‘crotchet’ the front part only, the upper dial holder has been modified by moving the hook loading through 180° so that the in and out cams can be inserted only in the space required.

The final part is made from terry with the insertion of coated Lycra with ribbing (any type of ribbing is possible) with the needles held so that the sock is elasticized and fits more closely around the foot.

The sock is made using a single-cylinder machine with 3¾ diameter, 168 needles and 36 gauge bearing in mind that it can also be made on other machines.

This item is made using an aluminium mould for the direct injection on the upper of a sole with four separate tread sections 11 where the mould comprises:
An aluminium last (on which the sock is mounted);
Side rings (with the design of the sole side);
Lower part piston (with the tread design).

The machine used for the injection on the upper is of the rotary type (Main Group 18 stations model T 403).

The material injected to form the raised tread sections 11 is Megol®, a material characterised by optimum grip and high injection fluidity.

The Megol® family of compounds offers the ideal combination of the elasticity, softness and aesthetics of rubbers and the low processing costs of thermoplastics. The formulation flexibility of Megol® allows the production of grades with a very wide hardness range, suitable for a variety of applications. They are ideal for injection and extrusion moulding, and are also available in grades which are nontoxic and/or for food use. The dominant matrix of these elastomer compounds is the thermoplastic block copolymers which belong to a number of different polymer families. Typically the Megol family belongs to the styrenic class of block copolymer (SEBS, SEPS) with a hydrogenated mid-block. However, there are grades of the product based on polymers of other origin. The hydrogenation process removes the double bonds in the material which is what gives these compounds their high levels of performance such as excellent age and UV light resistance.

These products are particularly well-suited to over-moulding and extrusion and have a rigid substrate which provides their soft-touch characteristics and general similarity to rubber.

The moulding process consists of a series of steps which are described in detail below.
Mounting the sock on the aluminium last;
Centring of the last on the fixturing;
Closing of the mould in three steps;
Downstroke of the last.
Closing of the side rings;
Upstroke of the tread piston;
Injection at low pressure and low speed with control of injection volume to ensure correct filling of the sole tread sections without creating flashing or surplus injection material. Injection volume control ensures that injected material does not pass through the sock knitwear and that the sole sections adhere correctly to the sock.
Post-injection cooling of the closed mould at a controlled temperature;
Opening of the mould and extraction of the injected sock;
Finishing and cutting off of the injection runners and sprues;
Final check;
Packing.

The footwear produced by this procedure has sole sections and differs from existing products as follows:
It can stretch;
The sole and the upper are not two distinct, separate parts but rather constitute a single piece.

The upper of the mule in this invention is made from a natural fibre obtained from milk (milk fibre) and can also be made from other fabrics. The fabrics used have the following characteristics which characterise the product and provide healthy footwear for the wearer.

The sole has a series of tread sections whose number and shape can be varied without altering the original characteristics of the design.

This mule slipper is different from traditional mules in that the special shape of the sole means that it can be stretched or shortened to fit persons with different shoe sizes without compromising the good fit and functionality of the mule.

This result is achieved as described above by positioning the sock inside a specially designed and constructed mould and injecting a ‘plastic’ material into the mould through well defined injection points. At the moment of injection the plastic material must have the precise liquidity, viscosity and temperature specified. The injection pressure is another important factor in determining the success of the injection moulding.

Once the injected material has cooled it forms a single piece with the sock without passing through the fibres comprising the sock.

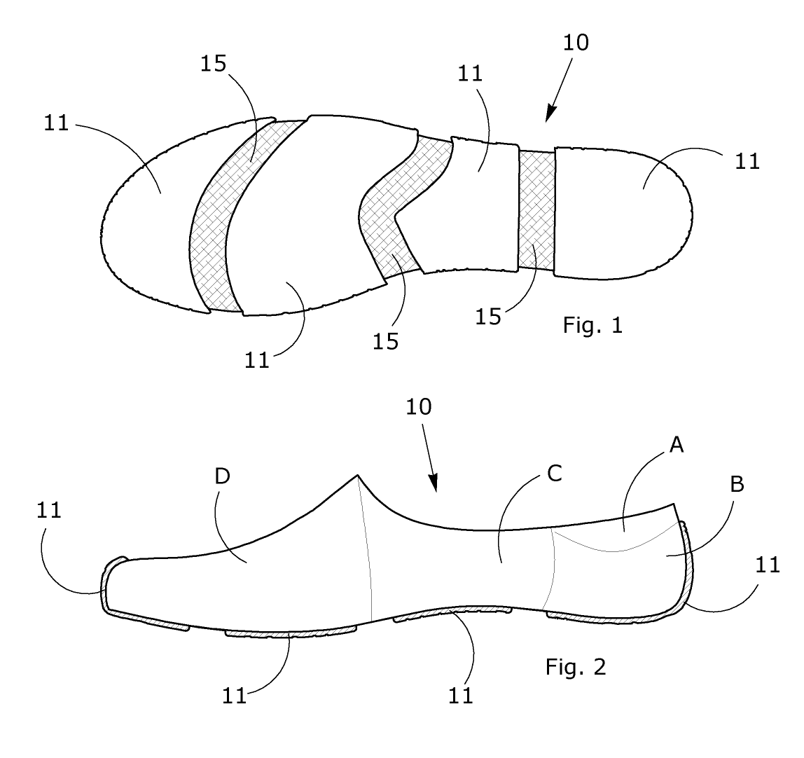

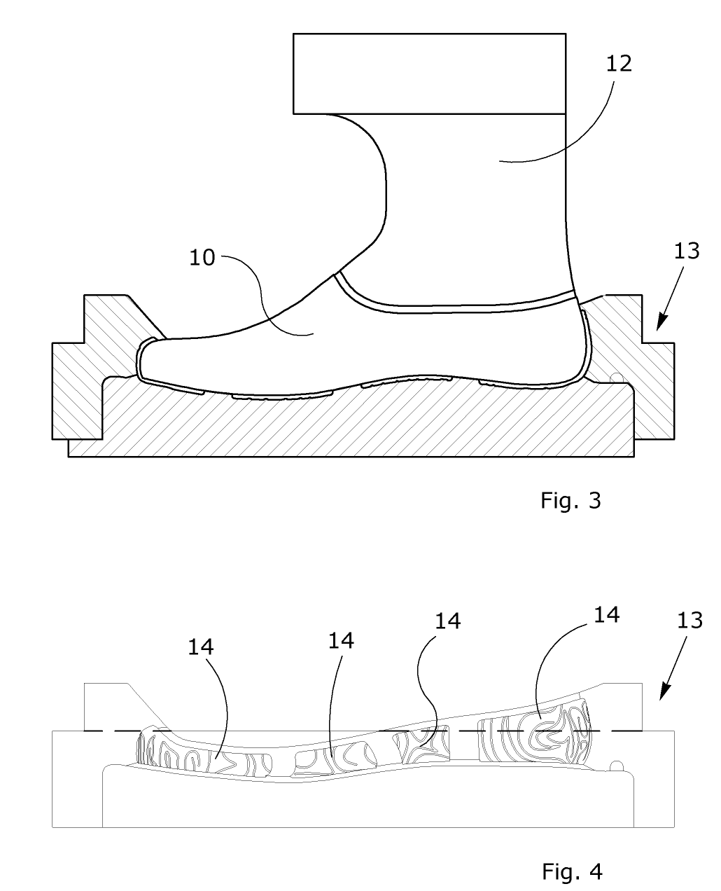

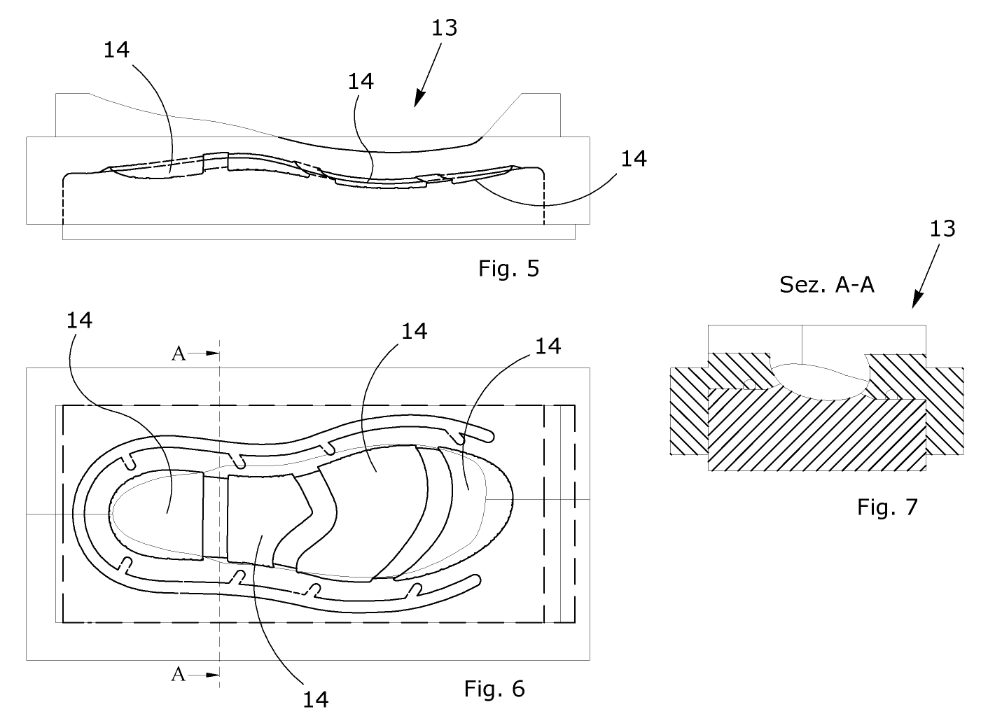

FIG. 1 shows that between the various sections 11 where the ‘plastic’ material is applied there are elasticized or stretching areas 15 which because they are made of an elasticized knit enable the footwear to stretch by a certain amount so that the same model can be used for multiple shoe sizes or measurements.

It would be possible to make a first mule model of a smaller size covering the size range from 35 to 40 and a second mule model of greater dimensions cover the sizes from 41 to 46.

This of course translates into an economic advantage for the manufacturer who with a very small number of models can meet the needs of a wide range of customers.

The invention as described above refers to a preferred embodiment. It is nevertheless clear that the invention is susceptible to numerous variations which lie within the scope of its disclosure, in the framework of technical equivalents.

1.-6. (canceled)

7. A method of making elasticized footwear, wherein the elasticized footwear comprises a knitted sock having thereon zones or tread sections of rubber or silicon material forming a sole in sections, the method comprising the following steps:
producing a sock using a machine to make several sections with different degrees of elasticity;
mounting the sock on an aluminum shoemaker's last;
inserting the sock mounted on the last into a mould to fill a cavity which is suitably shaped to form the raised tread sections which after injection are fixed to the sock to form the sole;
injecting a thermoplastic material into the mould in order to apply to the sole of the sock and adjoining areas one or more tread sections made from rubber or silicon material which adhere to the sock sole;
cooling of the closed mould at a controlled temperature; and
opening of the mould, extraction of the injected sock followed by finishing and cutting off of injection runners and sprues.

8. The method of claim 7, wherein the sock is made from an elasticized yarn such as Lycra, nylon or Milkofil or a combination of these in different percentages or in different sections.

9. The method of claim 8, wherein the sock is divided into four sections:
PART A has an initial edge made from 20% Lycra covered with 80% nylon;
PART B is made using Milkofil 20/1 comprising 35% milk fibre, 65% cotton with 14% Lycra interlaced with 86% nylon;
PART C is the same as part B; and
PART D is the same as parts B and C with the addition of 20% Lycra covered with 80% nylon.

10. The method of claim 7, wherein one or more tread sections of rubber or silicon material are applied to the sock using an aluminum mould for direct injection on the upper of a sole with four separate tread sections where the mould comprises:
an aluminium last (on which the sock is mounted);
side rings (with the design of the sole side);
lower part piston (with the tread design); and
wherein the machine used for the injection on the upper is of the rotary type (Main Group 18 stations model T 403) and the material injected to form the raised tread sections is Megol®.

11. The method of claim 7, wherein once the injected material has cooled it forms a single piece with the sock without passing through the fibres comprising the sock.

12. An item of elasticized footwear prepared by a process comprising the steps of:
producing a sock using a machine to make several sections with different degrees of elasticity;
mounting the sock on an aluminum shoemaker's last;
inserting the sock mounted on the last into a mould to fill a cavity which is suitably shaped to form the raised tread sections which after injection are fixed to the sock to form the sole;
injecting a thermoplastic material into the mould in order to apply to the sole of the sock and adjoining areas one or more tread sections made from rubber or silicon material which adhere to the sock sole;
cooling of the closed mould at a controlled temperature; and
opening of the mould, extraction of the injected sock followed by finishing and cutting off of injection runners and sprues.
